(19) United States
(12) Patent Application Publication
(10) Pub. No.: US 2016/0157645 A1
(43) Pub. Date: Jun. 9, 2016

(54) Stemware with Magnifying Base and Light Source

(71) Applicant: Regan Landon Bayless, Thousand Oaks, CA (US)

(72) Inventor: Regan Landon Bayless, Thousand Oaks, CA (US)

(21) Appl. No.: 14/753,789

(22) Filed: Jun. 29, 2015

Related U.S. Application Data
(60) Provisional application No. 62/087,892, filed on Dec. 5, 2014.

(51) Int. Cl. A47G 19/22; G02B 25/00; G02B 25/02; F21V 33/00; F21L 4/00

(52) U.S. Cl. CPC A47G 19/2227; A47G 19/2255; F21V 33/0036; F21L 4/00; G02B 25/02; G02B 25/002; A47G 2019/2238; A47G 2200/08

(57) ABSTRACT

A stemware drinking vessel comprising of a bowl, stem, and base, or “foot”, where the base below the stem is shaped and functions as a magnifying glass or magnification device. The base is clear and most commonly circular and dome shaped, with the stem attaching to base at the apex of the dome base. The clear magnifying glass base also has a light source built into the base, such as an LED, whose power supply is contained within the base. The light or lights within the base directs light downward, beneath the base, enabling the user, upon holding the stemware above the intended viewing object or reading material and looking through the base, to see both a magnified and lighted enhancement of what is below, such as a dining menu in a dimly lit restaurant to present the scrumptious desserts.

### BACKGROUND OF THE INVENTION

### Field of Invention

This invention relates to stemware, specifically stemware with a base (or “foot”) that is shaped and configured in such a way as to function as a magnifying glass or magnification device. In conjunction with the magnifying base of the stemware, this invention contains a light source within the base that is directed downward, beneath the base. This invention both magnifies and illuminates any object or reading material the stemware is placed upon or suspended above. Further, the part of the base that provides the lighting, if the lighting is contained in the perimeter of the base, can be physically detached from the magnification portion of the base, which results in the vessel being utilized as a traditional stemware vessel with a base shaped, intended, and used for magnification. The lighting portion of the base can always be reattached.

### SUMMARY OF INVENTION

When one goes out to eat and a drink, often times he or she cannot read the menu because of their declining eyesight and the notoriously dim light in the restaurant. Places like this are specifically designed for social gatherings, complimented by food and wine. When the lighting is poor, either naturally or intentionally to enhance the mood, it is often difficult, if not impossible to see the menu. This problem is compounded by the fact the menu is printed in small print and occasionally written in cursive.

If the entree or dessert menu were in focus without having to put on reading glasses, all would be fine. Add the element of darkness commonly found in restaurants, which some believe adds ambiance to the restaurant experience while others suspect hide filth within the restaurant, and reading the menu becomes extremely challenging. If one's stemware had a magnification component, such as one built into the base or foot of the stemware, in conjunction with a light contained within the perimeter of the base or located at the center of the base beneath where the stem attaches, enabling one to see the menu better, one would be able to combine a toast to your friends and read the dessert menu at the same time. This invention, and the optional use of the lights, will be helpful anywhere stemware is used, such as at home watching television, playing a board game, reading a cookbook, or relaxing in bed with a crossword puzzle. With the magnification component, and illuminating light ability, both integrated into the base of the stemware wine glass, one now has the ability to see the menu with clarity.

The portion of the base that is designed for lighting, if housed within an encasement around and underneath the perimeter or outer edge of the base, can be detached from the bowl, stem, and magnification component. This enables the remaining portion to be utilized and appear simply as a traditional stemware vessel, except for the magnification base remaining. The beneficial reason for the ability to detach the lighting component of the base from the bowl, stem, and magnification base portion of the vessel, is to significantly reduce the overall weight and bulkiness of the additional lighting components and be more visually and functionally consistent with traditional stemware. The detachable perimeter lighting portion of the base can be reattached at any time the user desires.

An example illustrating the benefit of this feature occurs after a main meal is ordered from a traditional hand held menu and the temporary necessity of either (or both) the lighting or magnification feature of the device has ended. The added weight of the components of this invention, such as the lighting encasement, LED lights, wiring and power supply on the device might seem distracting and uncomfortable to some. With the lighting feature and supporting elements detached, the stemware drinking vessel becomes simply a traditional stemware vessel with a magnification base. If, after some period of time and the main meal has concluded, diners often wish to view the dessert menu, once again giving rise to the necessity of light and magnification to view the print on the menu. To satisfy the desire of the user to read the menu, the lighting and associated components portion of the base can simply be reattached. Additionally, if one finds the main course not their satisfaction, and would like to order an alternative meal selection, or simply add something to their order, they could simply re-attach the lighting portion of the base to the magnification portion and the full benefits of this device are restored.

### Description of Prior Art

Several inventions have created illuminated stems within stemware, either by utilized electrical incandescent or chemiluminescent light sticks (U.S. Pat. No. 5,609,409, Diehl) to light up the stem. (U.S. Pat. No. 5,119,279, Makowsky; U.S. Pat. No. 5,070,435, Walker; U.S. Pat. No. 3,735,113, Douglas). However, all of the referenced patents are designed to only light up the stem, drinking vessel, liquid contained within, or direct light outwardly from the base. None are designed or intended to illuminate and direct light down, below the base, similar to a flashlight.

Additionally, no patent exists for stemware where the base of the stemware is designed to magnify objects external to the stemware. U.S. Pat. No. 5,123,190, Erberger, describes a non stemware drinking vessel that magnifies a photograph on the bottom and within the glass, but is not stemware and is not intended to view objects external to the drinking vessel. Further, U.S. Pat. No. 6,644,846, Willat, is a beverage tasting vessel with a magnification panel on the bowl intended to magnify the liquid within the bowl, but is also not stemware with a base intended to magnify anything external to the device.

The device described herein includes a base that both magnifies external objects and directs light downward with the intention of illuminating objects or reading material external to the device.

### BRIEF DESCRIPTION OF THE DRAWINGS

FIG. 1 is an external view of device, illustrating the bowl, stem, and base. The base is a magnifying glass and also includes a light emitting feature projecting downward.

FIG. 2 is a sectional profile view of the device, illustrating the magnifying glass or magnification element base, as well as one location for the lights, and light rays projecting downward.

FIG. 3 illustrates the device in use, suspended over written material, highlighting the magnification of print through the magnifying glass or magnification element base, as well as the illuminating feature of the lights underneath the base projecting downward and lighting up the dessert menu example.

FIG. 4 is an angled view from below device, illustrating the magnification element and perimeter base, underside base lights, stem and bowl.

FIG. 5 is a view from directly beneath the device looking straight up through the base, showing the lights focusing down (towards the viewer) and opposite the bowl, the battery compartment, and covered encasement around the perimeter of the base that both encases the lights and hides the wires from the battery to the lights.

### DETAILED DESCRIPTION OF DRAWINGS

As used herein, the term “base,” or “foot,” its derivatives, and grammatical equivalents refers to the portion of the stemware drinking vessel below the stem.

It is to be appreciated that various embodiments described herein can be implemented with variable shape, size, and volume in order to meet the demands of eyesight declining beverage connoisseurs while also providing many benefits inherent with the subject disclosure.

It is to be further appreciated that this disclosure allows for a stemware drinking vessel made of a variety of materials, such as glass, crystal, transparent plastic, such as, but not limited to polycarbonate, lexan, nalgene, and the like. Aspects, features, or advantages of the various embodiments can be exploited in substantially any type of material conducive to the functionality described herein. For example, the term “magnifying glass” used throughout is simply used generically and not intended to limit the magnification element to “glass”, but can be of any material that satisfies the described function of magnification.

The preferred embodiment of alternate embodiments are now described with reference to the drawings, wherein like reference numerals are used to refer to like elements throughout.

A stemware drinking vessel generally provides a bowl 10, stem 12, and base 14.

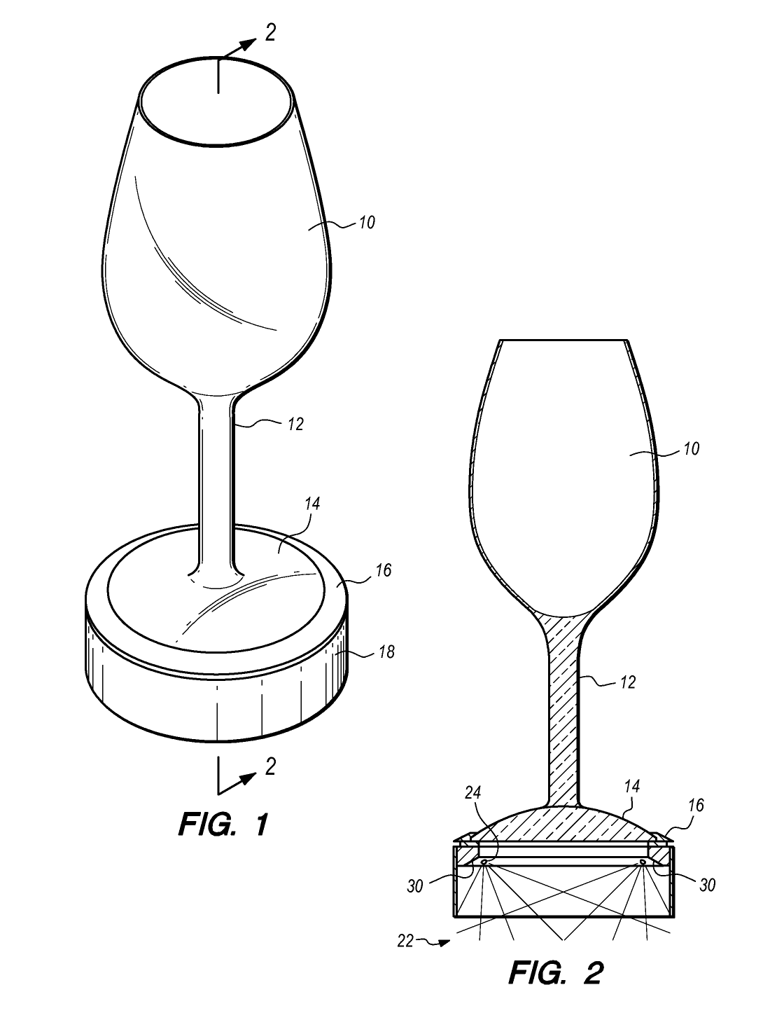

FIG. 1 illustrates an example of a known stemware drinking vessel bowl 10 and stem 12. The base of the FIG. 1 stemware illustrates the magnification element 14, perimeter ring 16 and solid base 18. Solid base 18 can be of any material. The stem 12 connects the bowl 10 with the magnification element 14. The magnification element 14, in conjunction with the perimeter ring 16 and perimeter base 18 is typically designed to allow the stemware drinking vessel to rest stably on a flat surface. However, the device is also intended to be held suspended above any reading material or object the user desired to magnify and illuminate from any distance the user desires for best viewing results.

FIG. 2 is a sectional view of FIG. 1, showing FIG. 1 cut in half in a vertical fashion. Magnification element 14 illustrates the round dome shape of the upper surface of the base to highlight the magnification element 14, although the magnification element 14 can be of any clear material. Furthermore, magnification element 14, which is domed shaped in this example, can be alternatively shaped as a square pyramid, or oval dome, so long as it satisfies the magnification function of the base, the invention's critical feature. The light(s) 24 are turn on and off when perimeter ring 16 on top of the base is pushed down on base 18 to create the connection between the battery and light(s) 24. FIG. 2 also illustrates the pluraly spaced light(s) 24 emitting light rays 22 in a downward direction as a flashlight and may be one, two, or more than two lights. Underside perimeter encasement 30 hides the battery pack and wiring used for the lights 24. The stem 12 is attached to the magnification element 14 at the apex of the base.

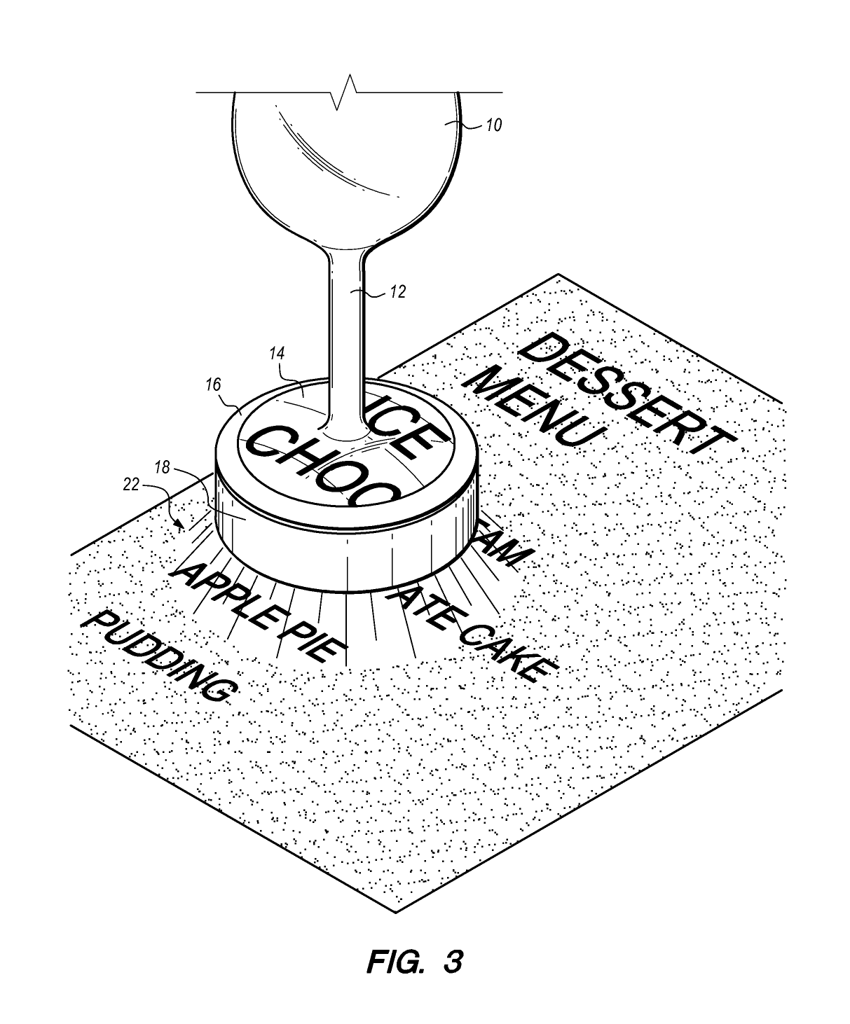

FIG. 3 illustrates the device in use with a dessert menu and highlighting both the magnification of the magnifying element base 14 and downward directed lighting of the lights 24. The lighting 24 are turned on by depressing the perimeter ring 16 against the cylinder base 18, creating a connection between the battery and the lights 24 through wires which are hidden along the perimeter encasement 30 within the underside of the base. The lighting, battery back, and wiring are encased and hidden from view in this FIG. 3 illustration.

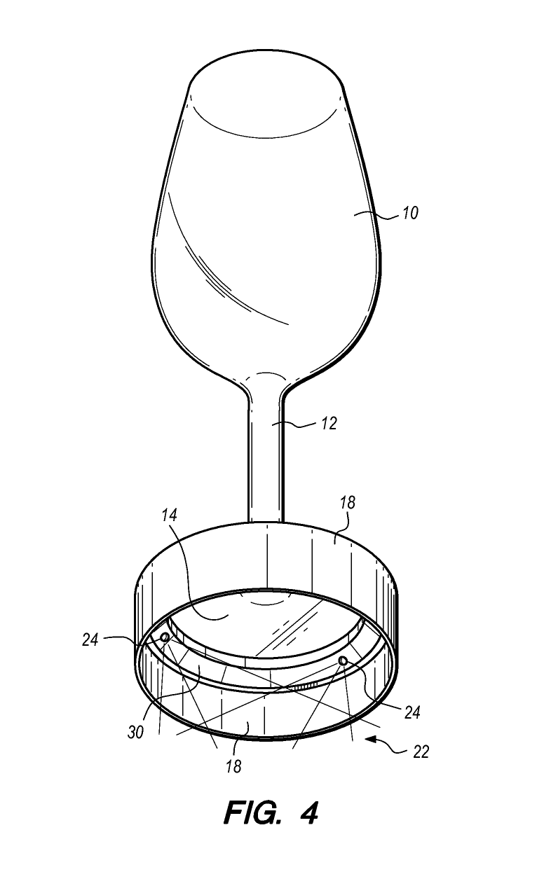

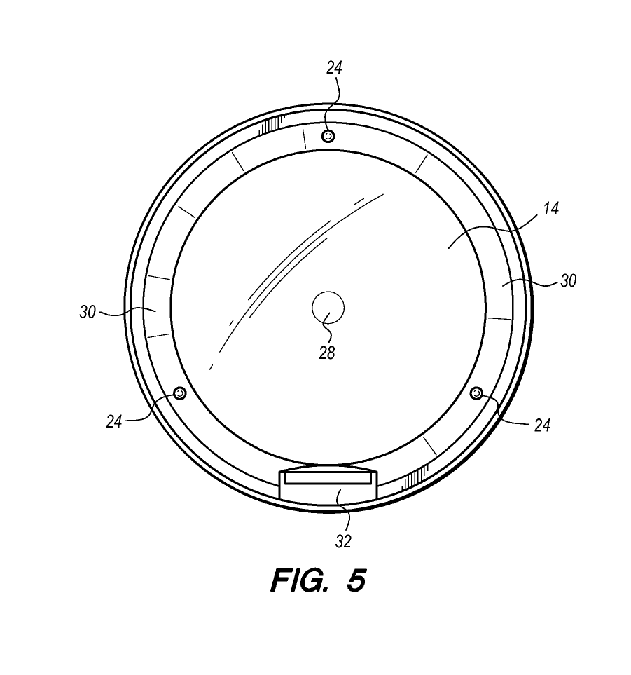

FIG. 4 illustrates a view from the underside of the device, showing bowl 10, stem 12, clear magnifying glass base 14, cylinder perimeter 18, lighting 24, underside encasement ring 30, and light emitting rays 22. The underside encasement ring 30 hides the wiring connecting the battery compartment to the one or multiple light(s).

FIG. 5 illustrates a view from directly below device looking up from beneath the base of the stemware, revealing the bottom of the stem 28 where attached to the base as seen though the clear magnifying element 14. Also shown are the lights 24, battery compartment 32, and underside encasement ring 30, which hides the wiring attaching the battery to the lights.

### DETAILED DESCRIPTION OF THE INVENTION

This invention is a drinking glass with a magnifying and light emitting base (also known as the “foot”). The invention applies to all stemware, be it a wine glass, water glass, martini glass or any drinking glass that comprises a bowl, stem and a base or foot. The base is shaped and designed as, and intended to function as, a magnifying glass or magnification device 14, as illustrated in FIG. 1-FIG. 5. The most common design of the base is a clear dome shaped magnifier 14, with the bottom of the stem attaching to the base at the apex of the base. However, the base is not limited to the shape of a clear dome magnifier. The base can be one of any number of shapes or designs that are intended to magnify. Additionally, the base of the stemware also contains a lighting source 24 secured within the perimeter of the base 18 that illuminates and projects down, analogous to a flashlight. The combination of the magnifying base and light source projecting down enables the user of the stemware to position the stemware and base on top of, or suspend above, any object or reading material that the user finds difficult to see or read due to the poor lighting and small print, typically found on restaurant menus in dimly lit environments, as illustrated in FIG. 3.

The shape of the clear base of the stemware glass can be round and dome shaped, oval, rectangular, square, or any combination thereof. The height of the base can vary from a couple of millimeters to five centimeters. The base 14 can be of differing magnification levels, such as three times magnification on one side of the base and six times on the other side. This invention is best utilized in dimly lit environments, such as restaurants that commonly have dining menus containing difficult or small print, FIG. 3.

The magnifying base 14 can be made of any clear material, such as glass, plastic, crystal, acrylic, or any material that will enable the user to use the device as intended. The perimeter of the base 18 can be made of, or contain, any material that supports the light element of the invention, associated wires, and battery compartment.

The lighting source 24 can be one or multiple battery operated lights, such as tiny LED (light emitting diode) lights. The tiny lights can be located at one point on the underside of the base, such as precisely below the stem, or equally around and underside of the perimeter of the base 18 if multiple lights are used. If located on the underside of the perimeter of the base, the lights are covered and encased by a decorative rim 30 which hides both the wiring and battery that powers the lights. All but the perimeter rim 18, battery compartment FIG. 5, 32, wiring, and lights of the base, is the magnification element 14 of the invention and therefore clear and see-through, except for the location where the stem is attached to the apex of the base).

The lights are turned on by either a button to the side or a push down mechanism on top of the base, but below the bowl and stem of the stemware. The lights turn on by pushing down on the top of the base, or the top of the perimeter metal rim which is integrated with and into the magnifying glass or magnification element of the invention, thereby creating a connection between the wires connecting the battery and the lights. The stemware's magnifying base, in conjunction with the embedded light(s) 24 projecting down like a flashlight, enables the user to read small and/or difficult print in dimly lit environments. The stemware drinking vessel is held by the bowl or stem, as is typical, and positioned some distance away from the reading material as determined by the one's eye sight ability.

The invention can also be only a stemware drinking vessel with only a magnification base and no light source.

The portion of the base that is designed for lighting 18, if housed within an encasement 30 around and underneath the perimeter or outer edge of the base, can be detached from the magnification component 14. The remaining stemware vessel will appear and continue to function as a traditional stemware vessel, with the magnification base remaining. The beneficial reason for the ability to detach the lighting component of the base from the bowl, stem, and magnification portion of the vessel, is to significantly reduce the overall weight of the stemware and be more visually and functionally consistent with traditional stemware. The perimeter lighting portion of the base can thereafter be reattached at any time the user desires.

The means by which detachment occurs can be through any number of methods. One option is by screwing in the magnification base into the cylinder shaped lighting encasement perimeter utilizing threads on the outside perimeter of the magnification base to threads on the inside of the lighting encasement perimeter cylinder to create a snug fit. An alternative method to attach and detach the magnification base 14 and the lighting encasement cylinder base 18 is simply by pushing the magnification base into the center of the perimeter lighting cylinder shaped component 18 and creating a snug fit as a result of the inside of the lighting cylinder base 18 which receives the magnification base 14 being slightly tapered to secure the connection. Any number of methods can be used to attach the magnification base to the lighting base component.

1. A stemware drinking vessel comprising of:
1. a bowl, stem, and base (or “foot”) below the stem, where the base is a magnifying glass or magnification device, shaped and designed to magnify anything the base is placed upon or suspended above;
2. a bowl, stem, and base (or “foot”) where the base includes a light source, located, encased and embedded within or around the perimeter of the base to illuminate and direct light downward, below the base, illuminating any object or reading material upon which the stemware is placed, held suspended above, shined upon, directed towards, or pointed towards, said light source employing at least one element selected from the group consisting of light emitting diodes (LEDs), optical wave guides, electroluminescent light sources, liquid crystal display (LCD), fluorescent displays, plasma displays, incandescent lights, fluorescent lights and fluorescent materials;
3. stemware according the claim 2, where the perimeter cylinder base containing the lighting components, including lights, wiring, power source, encasement components, can be detached and reattached to the magnification component of the base of the stemware;
4. a bowl, stem, and base (or “foot”) where the base contains a light source embedded within the base and located precisely beneath where the stem attaches to the apex of the base, positioned such that the light source illuminates and directs light downward, below the base, with the intent of illuminating any object or reading materials upon which the stemware is placed, held suspended above, shined upon, directed towards, or pointed towards, said light source employing at least one element selected from the group consisting of light emitting diodes (LEDs), optical wave guides, electroluminescent light sources, liquid crystal display (LCD), fluorescent displays, plasma displays, incandescent lights, fluorescent lights and fluorescent materials;
